(19) United States
(12) Patent Application Publication
(10) Pub. No.: US 2026/0151779 A1
(43) Pub. Date: Jun. 4, 2026

(54) REMOVABLE MODULAR IONIZATION TUBES FOR ELECTROSTATIC PRECIPITATORS

(71) Applicant: AirVitalize Innovations, Inc., PALMDALE, CA (US)

(72) Inventors: Serena Allen, Fairbanks, AK (US); Christopher Stokely, Houston, TX (US)

(21) Appl. No.: 19/406,173

(22) Filed: Dec. 2, 2025

Related U.S. Application Data
(60) Provisional application No. 63/726,967, filed on Dec. 2, 2024.

(51) Int. Cl. B03C 3/41; B03C 3/06; B03C 3/45

(52) U.S. Cl. CPC B03C 3/41; B03C 3/06; B03C 3/45; B03C 2201/08

(57) ABSTRACT

Systems, methods, and apparatus for removing airborne particulate matter from a gas stream using an electrostatic precipitator utilizing at least one horizontally positioned ionization assembly having a removable ionization tube and an electrode extending through its central portion to form an ionization zone. A high-voltage power supply energizes the electrode to generate a corona discharge, electrically charging particulate matter in the gas stream and causing it to be repelled toward the inner wall of the ionization tube. The tube or an inner lining containing collected particulates can be removed for disposal or further processing.

### CROSS-REFERENCE TO RELATED APPLICATIONS

This application claims the benefit of and priority to U.S. Provisional Application No. 63/726,967, filed Dec. 2, 2024. The entire specification and figures of the above-referenced application are hereby incorporated, in their entirety by reference.

### TECHNICAL FIELD

The present disclosure is directed to systems. methods and apparatus for the electrostatic precipitation of airborne particulate matter.

### BACKGROUND

Electrostatic precipitators (ESPs) have been widely utilized as an effective means of air pollution control, particularly in industrial settings where particulate emissions from factories must be mitigated. In a conventional ESP, a series of cathode rods generate an electrical discharge that creates a corona field, imparting an electrical charge to airborne particulates. These charged particulates are then attracted to and collected on anode surfaces, which are often configured as tubular or plate-like structures.

While ESPs are highly efficient in capturing fine particulate matter, they present significant challenges in terms of maintenance and longevity. Both the cathode and anode components are subject to wear, corrosion, and fouling over time, particularly when exposed to harsh industrial environments. Cleaning these components is critical to maintaining system performance; however, existing designs typically integrate the ionization elements in a fixed configuration, making removal for cleaning or replacement difficult and labor-intensive. Improper cleaning procedures can lead to component damage, resulting in costly repairs or complete system downtime. Furthermore, accumulated particulates on ionization elements can reduce charging efficiency, thereby diminishing the overall effectiveness of the ESP.

Current solutions lack a practical mechanism for easily removing and servicing the ionization tubes without dismantling major portions of the precipitator assembly. Accordingly, there is a need for an improved ESP design that incorporates one or more removable ionization tubes. Such a feature would allow operators to efficiently remove, clean, and replace the ionizing components without extensive disassembly, reducing maintenance costs, minimizing downtime, and extending the operational life of the precipitator.

### SUMMARY OF THE DISCLOSURE

The present disclosure is directed to systems, methods, and apparatus for airborne particulate, such as removing dust, pollution, and other particles from an external environment. In one preferred aspect, the disclosure provides for an electrostatic precipitator apparatus for removing particulate matter from a gas stream passing therethrough. In this preferred aspect, a frame supports at least one approximately horizontally positioned ionization assembly, and preferably a plurality of approximately horizontally positioned ionization assemblies, each assembly comprising a removable ionization tube and an electrode passing through the central portion of the ionization tube forming an ionization zone.

In a preferred aspect, a high-voltage power supply is electrically responsive to the electrode, such that when engaged it generates a corona discharge within the ionization zone, such that airborne particulate matter present in a gas stream passing through the ionization zone is electrically charged by the corona discharge, causing the particles to be electrostatically repelled toward the inner wall of the ionizing removable tube. The ionization tube, or an inner lining positioned within the central portion of the ionization tube containing the collected particulate matter, can be removed and particulate matter collected for disposal or additional downstream processing.

In another aspect, an inner lining is positioned within the central portion of the ionization tube.

In another aspect, the inner lining is separately removable from the ionization tube.

In another aspect, the inner lining comprises an electrically conductive inner lining.

In another aspect, the removable ionization tube comprises an electrically conductive removable ionization tube.

In another aspect, the high-voltage power supply is selected from a DC power supply or an AC power supply.

In another aspect, the particulate matter is negatively charged by the corona discharge, or the particulate matter is positively charged by the corona discharge.

In another aspect, the removable ionization tube is electrically charged with the opposite charge as the particulate matter, or wherein said inner lining tube is electrically charged with the opposite charge as the particulate matter.

In another aspect, the electrode is responsive to an electrification plate that is electrically responsive to the high-voltage power supply.

Additional aspects of the inventive technology will become apparent from the specification, figures, and claims below.

### BRIEF DESCRIPTION OF THE FIGURES

FIG. 1. Shows an isolated ionization assembly having an electrode responsive to a high-voltage power supply passing through the removable ionization tube in one embodiment thereof;

FIG. 2. Shows an isolated ionization assembly having an electrode passing through the removable ionization tube in one embodiment thereof;

FIG. 3. Shows an isolated ionization assembly having an inner lining positioned within the removable ionization tube in one embodiment thereof;

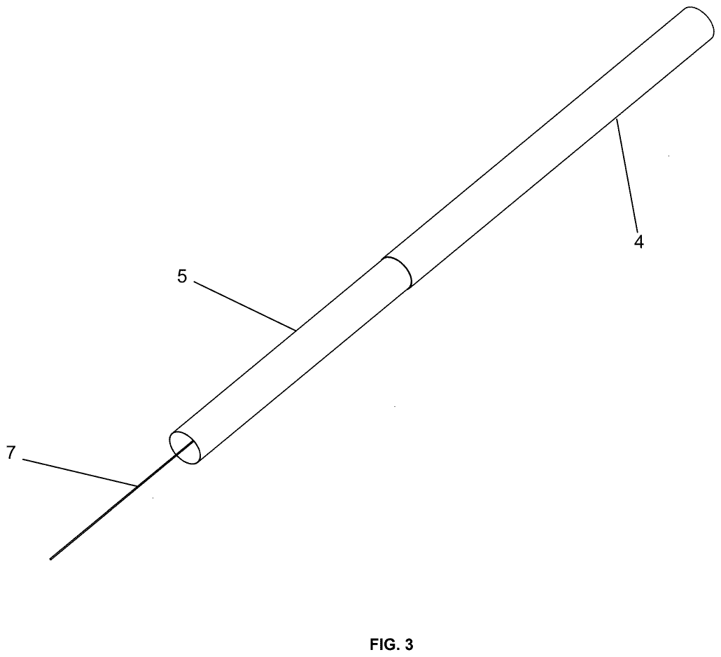

FIG. 4. Perspective view of an electrostatic precipitator having a plurality of horizontally positioned removable ionization assemblies in one embodiment thereof; and

FIG. 5. Exemplary industrial electrostatic precipitator ionization system known in the prior art incorporating static vertical collection tubes and cement receptacles for electrostatically collected particulate.

### DETAILED DESCRIPTION OF THE DISCLOSURE

As noted above, electrostatic precipitators or collectors generally comprise two functional zones: 1) an ionization zone where particulate matter suspended in a gas stream is electrically charged, typically by exposure to a corona discharge; and ) a collecting zone where the charged particulate matter is separated from the gas stream and transferred into a collection or receiving receptacle, such as hoppers or bins.

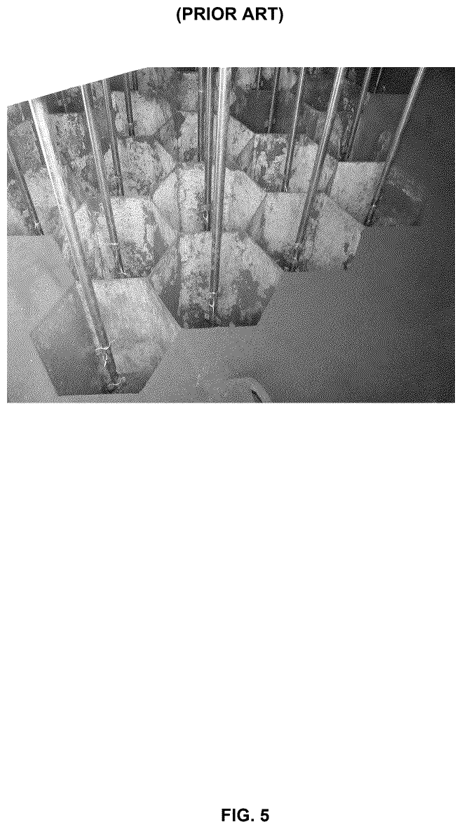

In conventional industrial implementations, as illustrated in FIG. 5, electrostatic precipitator ionization systems employ statically positioned vertical tubes. Each tube is configured to sustain a corona discharge generated by an electrode extending through the tube. In this arrangement, the corona discharge imparts an electrical charge to particulate matter entrained in the gas flow. The charged particles are then electrostatically repelled toward the inner wall of the tube. Subsequently, the particulate matter is allowed to traverse the length of the vertical tube and accumulate in stationary collection receptacles, such as the cement hoppers depicted in FIG. 5.

Although electrostatic precipitators configured in the above-described manner effectively capture fine particulates, their fixed ionization elements are prone to wear, fouling, and difficult cleaning, which reduces charging efficiency and can lead to costly damage or downtime.

To overcome the limitations of traditional electrostatic precipitators, the present disclosure provides for an improved electrostatic precipitator (1) incorporating one or more ionization assemblies (3), each assembly comprising an approximately horizontal removable ionizing tube (4) configured to sustain a corona discharge generated by an electrode (7) extending through the internal portion of the tube (4), forming an ionization zone (2). A gas stream (A), such as a stream of internal or external ambient air containing airborne particulate matter (P), can pass through the removable ionizing tube (4) where the corona discharge imparts an electrical charge to particulate matter (P), causing the particles to be electrostatically repelled toward the inner wall of the ionizing tube (4). In this configuration, the particulate matter (P) is generally retained on the inner portion of the ionizing tube (4). In this embodiment, the corona discharge can be removed, for example, by de-energizing the electrode (7) passing through the ionizing tube (4). The electrode can further be disengaged and temporarily removed from the internal portion of the ionizing tube (4).

It should be noted that in some embodiments, the particles are negatively charged by the corona discharge, while in alternative embodiments the particles are positively charged by the corona discharge. In each case, the charge imparted to the particles is controlled by the charge of the corona discharge generated by the electrode (7).

In another example, the present disclosure provides for an improved electrostatic precipitator (1) incorporating one or more ionization assemblies (3), each assembly comprising a removable ionizing tube (4) having an inner lining (5) that is configured to sustain a corona discharge generated by an electrode (7) extending through the internal portion of the tube (4), forming an ionization zone (2). In this preferred embodiment, a high-voltage power supply (6), such as a DC power supply or an AC power supply, fed by a power supply (8), is electrically responsive to the electrode (7) extending through the internal portion of the tube (4) and, when engaged, generates a positive or negatively charged corona discharge within the tube (4), forming an ionization zone (2). A gas stream containing, or potentially containing, airborne particulate matter (P) can be passed through the ionization zone (2) such that the particles are electrically charged by the corona discharge, causing the particles to be electrostatically repelled toward the inner wall of the ionizing removable tube (4).

Once a certain portion of gas has passed through the electrostatic precipitator (1), the high-voltage power supply (6) can be deactivated, thereby de-energizing the electrode (7) and causing the corona discharge to be removed. In this embodiment, the ionization tube (4), or an inner lining (5) positioned within the central portion of the ionization tube (4) containing the collected particulate matter (P), can be removed and the particulate matter (P) collected for disposal or additional downstream processing.

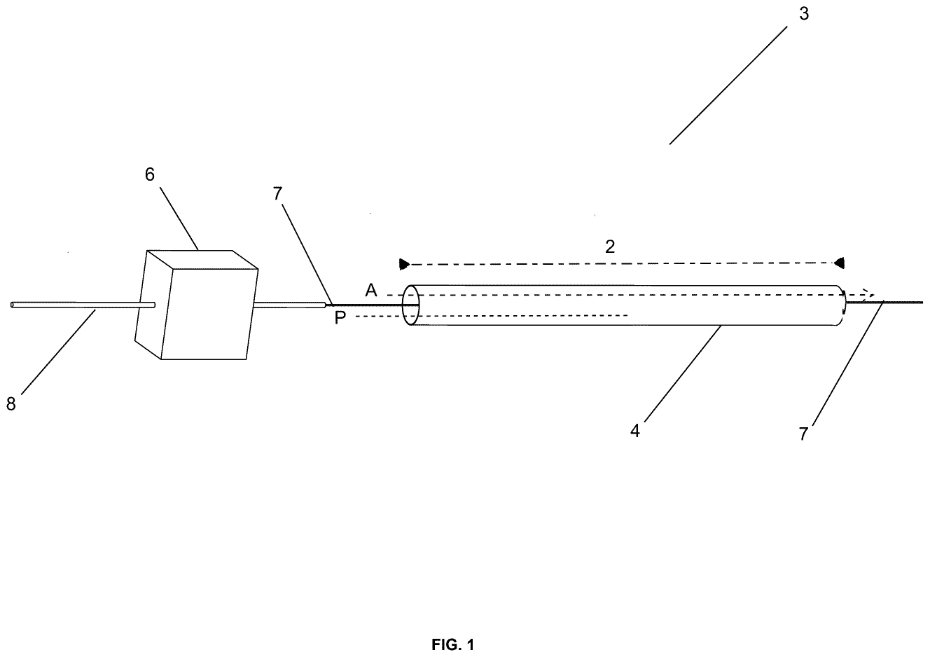

As shown in FIG. 1, in some embodiments ionization tubes (4) can be formed of a non-conductive material, such a plastic or corrugated cardboard and the like, while in alternative examples, ionization tubes (4) can be formed from electrically conductive material, such as an electrically conductive metal. In this configuration, the electrically conductive ionization tube (4) can be separately energized so as to have a positive or negative charge. In this embodiment, the charge of the electrically conductive ionization tube (4) is preferably the opposite of the charge imparted to the particulate matter (P) by the corona discharge within the ionization zone (2). In this embodiment, a gas stream containing, or potentially containing, airborne particulate matter (P) can be passed through the ionization zone (2) such that the particles are electrically charged by the corona discharge, causing the particles to be electrostatically repelled toward the inner wall of the ionizing removable tube (4), while the inner wall of the ionizing removable tube (4) carries a charge that is the opposite of the charge imparted to the particulate matter (P), causing the charged particles to adhere to the inner wall of the ionizing removable tube (4) while in an energized state. As noted above, the ionization tube (4) containing the collected particulate matter (P) can be removed and the particulate matter (P) collected for disposal or additional downstream processing.

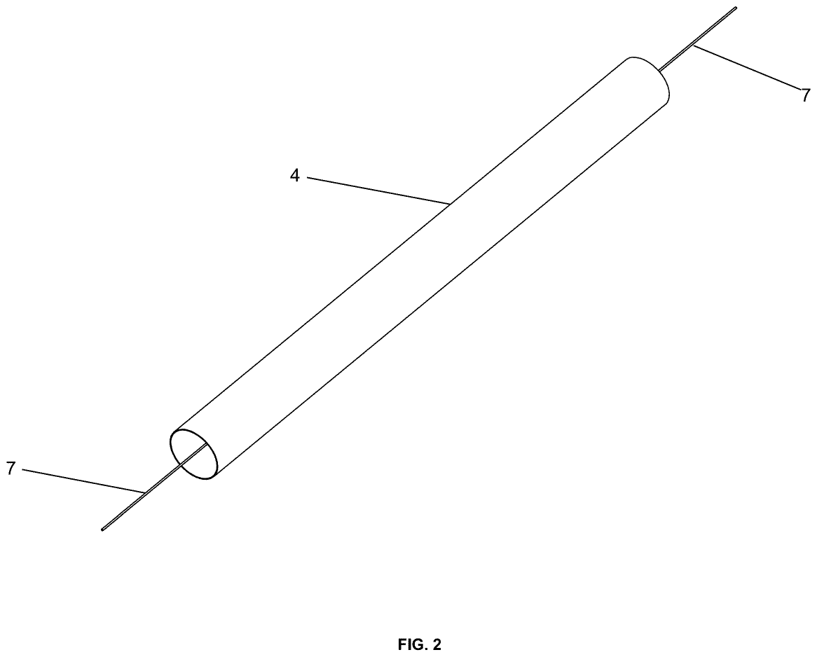

As shown in FIG. 2, in some embodiments the inner lining (5) can be formed of an electrically conductive material, such as an electrically conductive metal. In this configuration, the electrically conductive inner lining (5) can be separately energized so as to have a positive or negative charge. In this embodiment, the charge of the electrically conductive inner lining (5) is preferably the opposite of the charge imparted to the particulate matter (P) by the corona discharge within the ionization zone (2). In this embodiment, a gas stream containing, or potentially containing, airborne particulate matter (P) can be passed through the ionization zone (2) such that the particles are electrically charged by the corona discharge, causing the particles to be electrostatically repelled toward the inner wall of the ionizing removable tube (4), while the inner wall of the ionizing removable tube (4) comprises an oppositely charged electrically conductive inner lining (5), causing the charged particles to adhere to the inner lining (5) while in an energized state. As noted above, the inner lining (5) containing the collected particulate matter (P) can be removed and the particulate matter (P) collected for disposal or additional downstream processing.

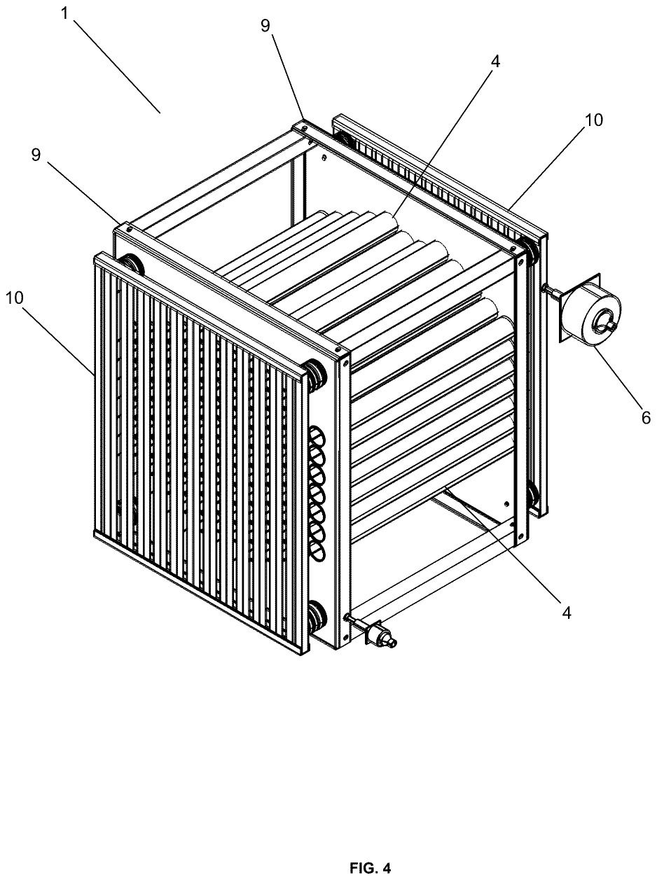

As shown in FIG. 4, an electrostatic precipitator (1) of the disclosure frame (9) supporting one, or preferably a plurality of ionization assemblies (3) each having removable ionization tube (4) and an electrode (7) passing through the central portion of the tube (4) forming an ionization zone (2). In this preferred embodiment, each electrode (7) is electrically responsive to one or more high-voltage power supplies (6). In one example, each electrode (7) is directly electrically responsive to one or more high-voltage power supplies (6), while in an alternative embodiment each electrode (7) is electrically responsive to an electrification plate (10) that is directly electrically responsive to a high-voltage power supply (6). In the embodiment shown in FIG. 5, the ionization assemblies (3) can be positioned in a honeycomb configuration and flanked by an electrification plate (10) and a removable cover (11), which in this embodiment can be used to secure the electrodes (7) that pass from the electrification plate (10) through the ionization tube (4). Notably, the connection of the electrodes (7) can be via a detachable coupler allowing for their quick release when removing the ionization tubes (4) or their inner linings (5), respectively.

As shown in FIG. 4, an electrostatic precipitator (1) of the disclosure includes a frame (9) supporting one, or preferably a plurality of ionization assemblies (3), each having a removable ionization tube (4) and an electrode (7) passing through the central portion of the tube (4), forming an ionization zone (2). In this preferred embodiment, each electrode (7) is electrically responsive to one or more high-voltage power supplies (6). In one example, each electrode (7) is directly electrically responsive to one or more high-voltage power supplies (6), while in an alternative embodiment each electrode (7) is electrically responsive to an electrification plate (10) that is directly electrically responsive to a high-voltage power supply (6). In the embodiment shown in FIG. 5, the ionization assemblies (3) can be positioned in a honeycomb configuration and flanked by an electrification plate (10) and a removable cover (11), which in this embodiment can be used to secure the electrodes (7) that pass from the electrification plate (10) through the ionization tube (4). Notably, the connection of the electrodes (7) can be via a detachable coupler, allowing for their quick release when removing the ionization tubes (4) or their inner linings (5), respectively.

Naturally, all embodiments discussed herein are merely illustrative and should not be construed to limit the scope of the inventive technology consistent with the broader inventive principles disclosed. As may be easily understood from the foregoing, the basic concepts of the present inventive technology may be embodied in a variety of ways. It generally involves systems, methods, techniques as well as devices to accomplish an electrostatic precipitator having one or more ionization assemblies. In this application, the methods and apparatus for the aforementioned systems are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the statements of invention. As can be easily understood from the foregoing, the basic concepts of the present invention may be embodied in a variety of ways. It involves both techniques as well as devices to accomplish the appropriate system. In this application, the techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in method-oriented terminology, each element of the claims corresponds to a device. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting any claims. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “coupler” should be understood to encompass disclosure of the act of “coupling”—whether explicitly discussed or not—and, conversely, were there effectively disclosure of the act of “coupling”, such a disclosure should be understood to encompass disclosure of a “coupling method and/or technique, and/or device.” Such changes and alternative terms are to be understood to be explicitly included in the description.

Any patents, publications, or other references mentioned in this application for patent, such as in the specification or an IDS are hereby incorporated herein by reference in their entirety. Any priority case(s) claimed by this application is hereby appended and hereby incorporated herein by reference in their entirety. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated herein by reference in their entirety. Finally, all references listed in the list of References To Be Incorporated By Reference In Accordance With The Patent Application or other information disclosure statement and the like filed with the application are hereby appended and hereby incorporated herein by reference in their entirety, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the methods and/or apparatus for providing a electrostatic precipitator having one or more ionization assemblies as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this, or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479F.3 d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. It should be understood that this application also provides support for any combination of elements in the claims and even incorporates any desired proper antecedent basis for certain claim combinations such as with combinations of method, apparatus, process, and the like claims.

Any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. The inventive subject matter is to include, but certainly not be limited as, a system substantially as herein described with reference to any one or more of the Figures and Description (including the following: for example, the process according to any claims and further comprising any of the steps as shown in any Figures, separately, in any combination or permutation).

What is claimed is:

1. An electrostatic precipitator for removing particulate matter from a gas stream passing therethrough comprising:
a frame supporting at least one horizontally positioned ionization assembly comprising:
a removable ionization tube;
an electrode passing through the central portion of the ionization tube forming an ionization zone;
a high-voltage power supply electrically responsive to the electrode, and configured to generate a corona discharge within the ionization zone; and
wherein airborne particulate matter present in a gas stream passing through the ionization zone is electrically charged by the corona discharge causing the particles to be electrostatically repelled toward the inner wall of the ionizing removable tube.

2. The electrostatic precipitator of claim 1, and further comprising an inner lining positioned within the central portion of the ionization tube.

3. The electrostatic precipitator of claim 2, wherein said inner lining is separately removable from the ionization tube.

4. The electrostatic precipitator of claim 2, wherein said inner lining comprises an electrically conductive inner lining.

5. The electrostatic precipitator of claim 1, wherein said removable ionization tube comprises an electrically conductive removable ionization tube.

6. The electrostatic precipitator of claim 1, wherein said high-voltage power supply is selected from a DC power supply, or an AC power supply.

7. The electrostatic precipitator of claim 1, wherein the particulate matter is negatively charged by the corona discharge, or wherein the particulate matter is positively charged by the corona discharge.

8. The electrostatic precipitator of claim 2, wherein said removable ionization tube is electrically charged with the opposite charge as the particulate matter, or wherein said inner lining tube is electrically charged with the opposite charge as the particulate matter.

9. The electrostatic precipitator of claim 1, wherein said electrode is responsive to an electrification plate that is electrically responsive to the high-voltage power supply.

10. A method of removing airborne particulate matter from a gas stream via electrostatic precipitation, the method comprising:
establishing an electrostatic precipitator having at least one horizontally positioned ionization assembly comprising:
a removable ionization tube;
an electrode passing through the central portion of the ionization tube forming an ionization zone;
generating a corona discharge within the ionization zone;
passing a gas stream through the ionization zone, wherein airborne particulate matter present in a gas stream passing through the ionization zone is electrically charged by the corona discharge causing the particles to be electrostatically repelled toward the inner wall of the ionizing removable tube; and
withdrawing the corona discharge and removing the ionization tube, or an inner lining positioned within the central portion of the ionization tube containing the collected particulate matter.

11. The method of claim 10, wherein said inner lining comprises an electrically conductive inner lining.

12. The method of claim 10, wherein said removable ionization tube comprises an electrically conductive removable ionization tube.

13. The method of claim 10, wherein said high-voltage power supply is selected from a DC power supply, or an AC power supply.

14. The method of claim 10, wherein the particulate matter is negatively charged by the corona discharge.

15. The method of claim 10, wherein the particulate matter is positively charged by the corona discharge.

16. The method of claim 10, further comprising electrically charging said removable ionization tube with the opposite charge as the particulate matter, or electrically charging said inner lining with the opposite charge as the particulate matter.

17. The method of claim 10, further comprising electrically charging said inner lining with the opposite charge as the particulate matter,

18. The method of claim 10, wherein said electrode is responsive to an electrification plate that is electrically responsive to the high-voltage power supply.

19. The method of claim 10, wherein said gas stream comprises a stream of ambient air.

20. The method of claim 19, wherein said ambient air comprises ambient air from an external environment.
